(19) United States
(12) Patent Application Publication
(10) Pub. No.: US 2017/0171166 A1
(43) Pub. Date: Jun. 15, 2017

(54) Anti-hotlinking method and electronic device

(71) Applicants: Le Holdings (Beijing) Co., Ltd., Beijing (CN); LeCloud Computing Co., Ltd., Beijing (CN)

(72) Inventors: Ming LI, Beijing (CN); Ruiqian ZHAO, Beijing (CN)

(21) Appl. No.: 15/246,537

(22) Filed: Aug. 25, 2016

Related U.S. Application Data
(63) Continuation of application No. PCT/CN2016/089470, filed on Jul. 8, 2016.

(30) Foreign Application Priority Data
Dec. 11, 2015 (CN) 201510921246.7

(51) Int. Cl. H04L 29/06; H04N 7/167; H04N 21/266; H04N 21/4405; G06F 17/30; H04N 21/854; H04N 21/472; H04N 21/658; H04N 21/258; H04L 29/08; H04N 21/8352

(52) U.S. Cl. CPC H04L 63/0428; H04L 67/06; H04L 65/4069; H04N 7/1675; H04N 21/26606; H04N 21/4405; H04N 21/8352; H04N 21/85406; H04N 21/47202; H04N 21/6581; H04N 21/25816; G06F 17/30858; G06F 17/30091; G06F 17/30817

(57) ABSTRACT

Disclosed are an anti-hotlinking method and an electronic device. The method includes: receiving request information sent by a client for acquiring a video file; determining a video file corresponding to the request information according to the request information and encrypting the video file; and sending the encrypted video file to the client so that the client decrypts the encrypted video file and plays the decrypted video file.

### CROSS REFERENCE TO RELATED APPLICATIONS

This application is a continuation of International Application No. PCT/CN2016/089470, filed on Jul. 8, 2016, which is based upon and claims priority to Chinese Patent Application No. 201510921246.7, filed on Dec. 11, 2015, the entire contents of all of which are incorporated herein by reference.

### TECHNICAL FIELD

The present disclosure relates to internet technologies, and more particularly, to an anti-hotlinking method and an electronic device.

### BACKGROUND

With the development of Internet technologies, users in application network increasingly grow and users may acquire various required resources via the network, for example, watching network video programs and so on. However, fluency and quality in watching network video programs for users are restricted by network environments such as network bandwidth, network speed and network traffic, etc. Therefore, in order to improve the user experience in watching network video programs for users, links on the Internet that may likely have a negative effect on video data transmission speed and stability need to be avoided so that video data can be transmitted more quickly and more stably.

At present, there are many providers providing video data for users, for their own development needs, these providers may develop video players of their own, and users can watch videos provided by these providers by means of these video players. In order to provide video data for users more quickly and more stably, some providers providing video data may establish a Content Delivery Network (CDN), and provide video data for users through the CDN system. A CDN system can reorientate, in real time, a request for acquiring contents sent by a user to a service node closest to the user according to comprehensive information such as network traffic, connections and loads of nodes, and a distance and response time from each node to the user, thereby allowing the user to acquire required contents nearby, solving a problem of network congestion, and improving response speed in acquiring video data for the user.

A CDN system is complex in technology research and development and high in operation and maintenance cost, and many providers providing video data do not have enough funds to establish a CDN system. Therefore, in order to reduce cost in acquiring video data, some malicious third party providers or illegal users generally may simulate behaviors of a video player having a CDN system and send a request for acquiring video data to a CDN system of an opposite party so as to acquire video data from the CDN system of the opposite party for free. A problem of loss of video data of a CDN system and waste of resources of the CDN system may be caused due to failure of implementation of hotlinking detection of the CDN system.

### SUMMARY

The present disclosure provides an anti-hotlinking method and an electronic device to solve the problem in the prior art that failure of implementation of hotlinking detection of a CDN system causes loss of video data of the CDN system and waste of resources of the CDN system.

In a first aspect, embodiments of the present disclosure provide an anti-hotlinking method, implemented by a server, including:

receiving request information sent by a client for acquiring a video file;

determining a video file corresponding to the request information according to the request information and encrypting the video file; and

sending the encrypted video file to the client so that the client decrypts the encrypted video file and plays the decrypted video file.

In a second aspect, embodiments of the present disclosure provide a non-transitory computer-readable storage medium storing executable instructions, wherein the executable instructions are configured to perform any anti-hotlinking methods mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any anti-hotlinking methods mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 illustrates a flowchart of an anti-hotlinking method in accordance with some embodiments;

FIG. 2 illustrates a block diagram showing the composition of an anti-hotlinking apparatus in accordance with some embodiments;

FIG. 3 illustrates a block diagram showing the composition of another anti-hotlinking apparatus in accordance with some embodiments;

FIG. 4 illustrates a schematic structural diagram of a server in accordance with some embodiments; and

FIG. 5 is a block diagram of an electronic device which is configured to perform the anti-hotlinking methods in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

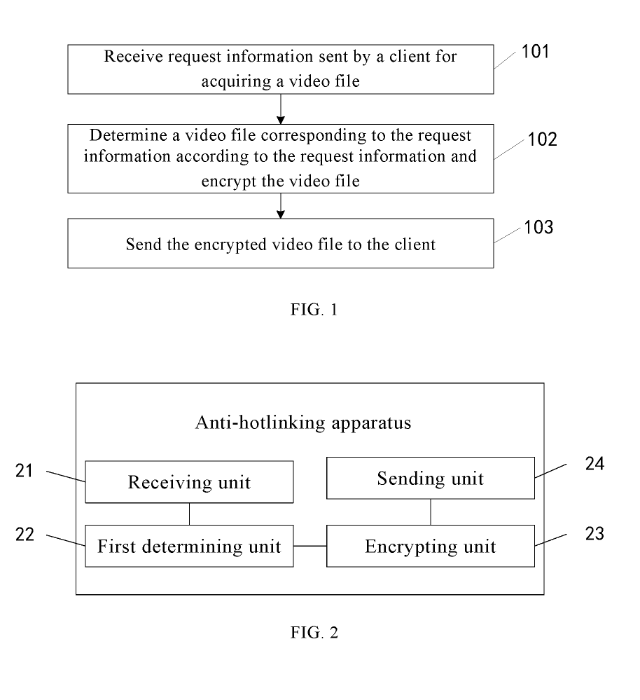

Embodiments of the present disclosure provide an anti-hotlinking method, as shown in FIG. 1, the method includes:

101: request information sent by a client for acquiring a video file is received.

In the prior art, when acquiring a video file based on a client, a client user needs to send request information for acquiring the video file to a server through the client, and the server receives the request information sent by the client for acquiring the video file, and acquires the video file according to address information in the request information. Generally, video files are distributed and stored in a Content Delivery Network (CDN).

102: a video file corresponding to the request information is determined according to the request information and the video file is encrypted.

For the convenience of management of video files, these video files are stored in a preset database by a server. When receiving request information sent by the client for acquiring a video file, the server acquires the required video file from the preset database based on the request information.

It is to be noted that when the server stores video files, it is unnecessary to encrypt these video files. In the encryption a video file in the embodiments of the present disclosure, the video file is a video file to be sent to the client instead of a video file stored in the preset database by the server. During specific implementation, since the CDN is higher in operation and maintenance cost, before a video file is sent to the client, the video file is encrypted to prevent a malicious third party provider or an illegal user from embezzling the video file in the CDN, thereby avoiding waste of resources of video data.

A basic process of file encryption is to process a file or data originally in plaintext according to a certain algorithm so that the file or data become a piece of unreadable code, which is generally referred to as a “ciphertext”, and original contents of the file or data cannot be displayed unless a corresponding secret key is inputted. In this way, a video file is protected from illegal interception. In the embodiments of the present disclosure, encryption of a video file can be implemented by using but not limited to following modes: symmetric encryption or asymmetric encryption, for example, Data Encryption Standard (DES), RC2 and RC4, International Data Encryption Algorithm (IDEA), RSA, Digital Signature Algorithm (DSA), MD5 and SSF33, etc. A specific mode for implementing encryption of a video file is not limited in the embodiments of the present disclosure.

103: the encrypted video file is sent to the client.

After the encrypted video file is decrypted, the client plays the decrypted video file.

By using the anti-hotlinking method provided by the embodiments of the present disclosure, a server receives request information sent by a client for acquiring a video file, determines a corresponding video file according to the request information and encrypts the video file before the video file is sent to the client. Compared with the prior art in which failure of implementation of hotlinking detection of a CDN system causes loss of video data of the CDN system, in the embodiments of the present disclosure, from a standpoint of security of the video file, the video file is encrypted to ensure that neither a malicious third party provider nor an illegal user can acquire the video file, thereby avoiding loss of website data resources and waste of system resources.

It is to be noted that the video file mentioned in the embodiments of the present disclosure is an M3U8 file which refers to an M3U file having a UTF-8 coded format. The M3U file records an indexed plain text file. When the client opens the M3U file, the M3U file is not played, instead a network address of a corresponding video file is searched for according to indexes recorded in the M3U file for an online playback.

Further, to prevent some malicious third party providers or illegal users from embezzling a video file of the CDN, in the server, generally an authorized device identifier is configured for the client of the server. When the client of the server sends request information for acquiring a video file to the server, the authorized device identifier can be carried in the request information to indicate that the request information is sent by the client of the server. In this way, security of the video file of the CDN can be ensured. Before determining a video file corresponding to the request information according to the request information, the server parses the received request information to determine whether the request information includes an authorized device identifier, and neglects the request information when it is determined that the request information does not include the authorized device identifier, or determines the video file requested by the request information when it is determined that the request information includes the authorized device identifier.

It is to be noted that after determining that the request information includes the authorized device identifier, the server also needs to encrypt the video file requested by the client so as to prevent unencrypted video data from intercepting by a malicious third party provider or an illegal user in a process of sending the video file by the server to the client, thereby avoiding waste of resources of CDN video data.

As an implementation of the embodiments of the present disclosure, when determining a video file requested by the client according to received request information, the server can adopt but not limited to following modes, for example: traversing a preset database based on the request information, where the preset database is configured to store video files; and determining and acquiring the video file corresponding to the request information from the preset database. Reference is made to related description in the prior art with regard to a specific mode for implementation of traversing the preset database, which is not unnecessarily elaborated any more in the embodiments of the present disclosure.

Further, to ensure the client can decrypt and play the encrypted video file, an encryption protocol of the video file is generated before the server encrypts the video file, where the encryption protocol is used for instructing the client to decrypt the encrypted video file received, and the encryption protocol may include but is not limited to following contents such as an encryption algorithm, a secret key or other information; and after the encryption protocol of the video file is generated, the video file is encrypted according to the encryption protocol.

In order to more clearly describe the server generating the encryption protocol of the video file, reference will now be made in the form of an example. As an implementation of the embodiments of the present disclosure, when generating an encryption protocol of a video file, the server can generate corresponding encryption protocols for different clients, namely, each client can have a unique encryption protocol, which is unrelated to a type of the acquired video file sent by the client. Exemplarily, an authorized device identifier of the client is “LE-001”, the encryption protocol generated by the server includes an encryption algorithm DES and a secret key abc . . . ; the encryption protocol of an acquired video file I sent by the client whose authorized device identifier is “LE-001” includes the encryption algorithm DES and the secret key abc . . . ; and the encryption protocol of an acquired video file I sent by the client whose authorized device identifier is “LE-001” still includes the encryption algorithm DES and the secret key abc . . . . The above example is merely an exemplary example, and embodiments of the present disclosure do not specifically limit information such as the authorized device identifier, and contents included in the encryption protocol, etc.

As another implementation of the embodiments of the present disclosure, when generating an encryption protocol of a video file, the server also can generate corresponding encryption protocols for different video files, namely each video file can have a unique encryption protocol, which is unrelated to the client. Exemplarily, if an encryption protocol directed at a video file III includes an encryption algorithm IDEA and a secret key ABC . . . , when a client 1 acquires the video file III, the encryption protocol directed at the video file III still includes the encryption algorithm IDEA and the secret key ABC . . . ; and when a client 2 acquires the video file III, the encryption protocol directed at the video file III includes the encryption algorithm IDEA and the secret key ABC . . . . The above example is merely an exemplary example, and embodiments of the present disclosure do not limit a video file, an encryption algorithm, and a secret key, etc.

It is to be noted that in order to ensure the security of a video file, when an encryption protocol is generated for a video file, an encryption algorithm and a secret key included in the encryption protocol need to be modified or altered periodically.

Further, as implementation of the method as shown in FIG. 1, another embodiment of the present disclosure further provides an anti-hotlinking apparatus. The apparatus embodiment corresponds to the foregoing method embodiment, and for ease of reading, detailed contents in the foregoing method embodiment are not unnecessarily described one by one in the apparatus embodiment. However, it shall be clear that the apparatus in this embodiment can correspondingly implement all the contents in the foregoing method embodiment. An embodiment of the present disclosure provides an anti-hotlinking apparatus, as shown in FIG. 2, the apparatus includes:

a receiving unit 21, configured to receive request information sent by a client for acquiring a video file;

a first determining unit 22, configured to determine a video file corresponding to the request information according to the request information received by the receiving unit;

an encrypting unit 23, configured to encrypt the video file determined by the first determining unit 22; and

a sending unit 24, configured to send the video file encrypted by the encrypting unit 23 to the client so that the client decrypts the encrypted video file and plays the decrypted video file.

Further, the video file is an M3U8 file.

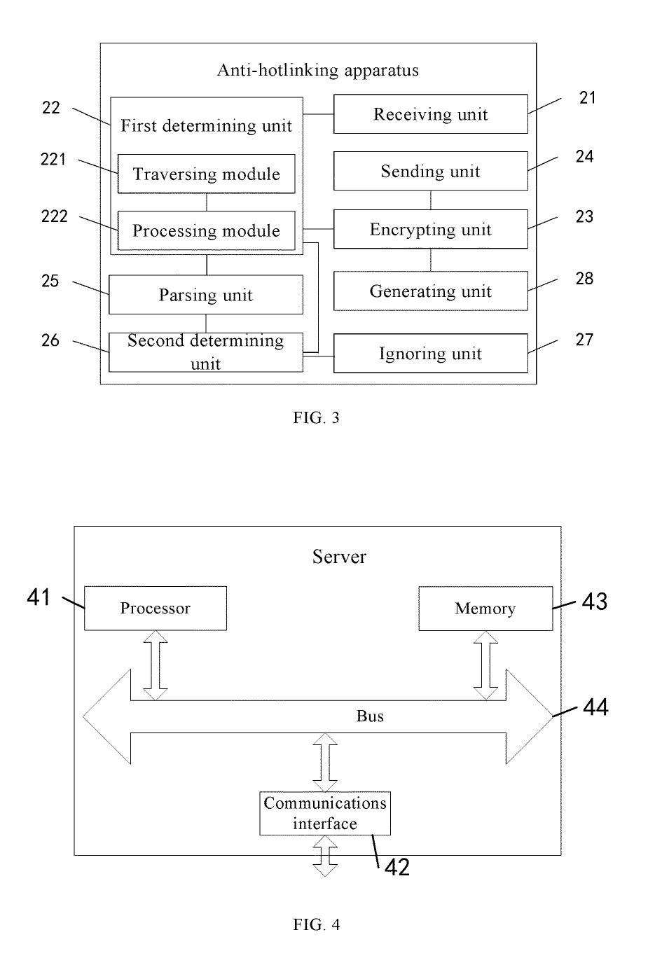

Further, as shown in FIG. 3, the apparatus further includes:

a parsing unit 25, configured to parse the request information before the first determining unit 22 determines a video file corresponding to the request information according to the request information;

a second determining unit 26, configured to determine whether the request information includes an authorized device identifier after the parsing unit 25 parses the request information, where the authorized device identifier is generated by a server and is a unique identifier of the client;

an ignoring unit 27, configured to ignore the request information when the second determining unit 26 determines that the request information does not include the authorized device identifier; and

the first determining unit 22, further configured to determine the video file corresponding to the request information when the second determining unit 26 determines that the request information includes the authorized device identifier.

Further, as shown in FIG. 3, the apparatus includes:

a generating unit 28, configured to generate an encryption protocol of the video file before the encrypting unit 23 encrypts the video file, where the encryption protocol is used for instructing the client to decrypt the encrypted video file; and

the encrypting unit 23, further configured to encrypt the video file according to the encryption protocol generated by the generating unit 28.

Further, as shown in FIG. 3, the first determining unit 22 includes:

a traversing module 221, configured to traverse a preset database based on the request information, where the preset database is configured to store the video file; and

a processing module 222, configured to determine and acquire the video file corresponding to the request information from the preset database after the traversing module 221 traverses the preset database based on the request information.

By using the anti-hotlinking apparatus provided by embodiments of the present disclosure, a server receives request information sent by a client for acquiring a video file, determines a corresponding video file according to the request information and encrypts the video file before the video file is sent to the client. Compared with the prior art in which failure of implementation of hotlinking detection of a CDN system causes loss of video data of the CDN system, in the embodiments of the present disclosure, from a standpoint of security of the video file, the video file is encrypted to ensure that neither a malicious third party provider nor an illegal user can acquire the video file, thereby avoiding loss of website data resources and waste of system resources.

It is to be noted that in allusion to the foregoing anti-hotlinking apparatus, functions of each unit module used in the embodiments of the present disclosure can be implemented through a hardware processor.

Exemplarily, as shown in FIG. 4, which shows a schematic structural diagram of a server according to embodiments of the present disclosure, the server can include: a processor 41, a communications interface 42, a memory 43 and a bus 44, where the processor 41, the communications interface 42 and the memory 43 complete communications among each other through the bus 44. The communications interface 42 can be configured to implement information transmission between the server and the client. The processor 41 can invoke a logic instruction in the memory 43 to execute the following method: receiving request information sent by a client for acquiring a video file; determining a video file corresponding to the request information according to the request information and encrypting the video file; and sending the encrypted video file to the client so that the client decrypts the encrypted video file and plays the decrypted video file.

In addition, when a logic instruction in the foregoing memory 43 can be implemented in the form of a software functional unit and is sold or used as an independent product, the logic instruction can be stored in a computer-readable storage medium. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any anti-hotlinking methods mentioned by embodiments of the present disclosure.

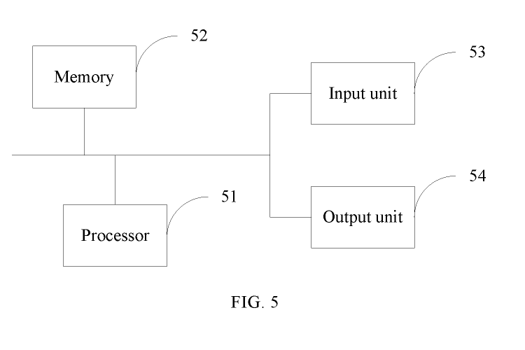

FIG. 5 is a block diagram of an electronic device which is configured to perform the anti-hotlinking methods according to an embodiment of the present disclosure. As shown in FIG. 5, the device includes:

one or more processors 51 and memory 52. A processor 51 is showed in FIG. 5 for an example.

Device which is configured to perform the anti-hotlinking methods can also include: input unit 53 and output unit 54.

Processor 51, memory 52, input unit 53 and output unit 54 can be connected by BUS or other methods, and BUS connecting is showed in FIG. 5 for an example.

Memory 52 can be used for storing non-transitory software program, non-transitory computer executable program and modules as a non-transitory computer-readable storage medium, such as corresponding program instructions/modules for the anti-hotlinking methods mentioned by embodiments of the present disclosure (such as shown in FIG. 2 receiving unit 21, first determining unit 22, encrypting unit 23 and sending unit 24). Processor 51 performs kinds of functions and transcoding a live video of the electronic device by executing non-transitory software program, instructions and modules which are stored in memory 52, thereby realizes the anti-hotlinking methods mentioned by embodiments of the present disclosure.

Memory 52 can include program storage area and data storage area, thereby the operating system and applications required by at least one function can be stored in program storage area and data created by using the anti-hotlinking device can be stored in data storage area. Furthermore, memory 52 can include high speed Random-access memory (RAM) or non-volatile memory such as magnetic disk storage device, flash memory device or other non-volatile solid state storage devices. In some embodiments, memory 52 can include long-distance setup memories relative to processor 51, which can communicate with the anti-hotlinking device by networks. The examples of said networks are including but not limited to Internet, Intranet, LAN, mobile Internet and their combinations.

Input unit 53 can be used to receive inputted number, character information and key signals causing user configures and function controls of the anti-hotlinking device. Output unit 54 can include a display screen or a display device.

The said module or modules are stored in memory 52 and perform the methods for transcoding a live video when executed by one or more processors 51.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. An anti-hotlinking method, implemented by a server, comprising:
receiving request information sent by a client for acquiring a video file;
determining a video file corresponding to the request information according to the request information and encrypting the video file; and
sending the encrypted video file to the client so that the client decrypts the encrypted video file and plays the decrypted video file.

2. The method according to claim 1, wherein the video file is an M3U8 file.

3. The method according to claim 2, wherein before determining a video file corresponding to the request information according to the request information, the method further comprises:
parsing the request information to determine whether the request information comprises an authorized device identifier, wherein the authorized device identifier is generated by a server and is a unique identifier of the client; and
ignoring the request information when determining the request information does not comprise the authorized device identifier; and
the determining a video file corresponding to the request information according to the request information comprises:
determining the video file corresponding to the request information when determining the request information comprises the authorized device identifier.

4. The method according to claim 1, wherein before encrypting the video file, the method comprises:
generating an encryption protocol of the video file, wherein the encryption protocol is used for instructing the client to decrypt the encrypted video file; and
the encrypting the video file comprises:
encrypting the video file according to the encryption protocol.

5. The method according to claim 4, wherein the determining a video file corresponding to the request information according to the request information comprises:
traversing a preset database based on the request information, wherein the preset database is configured to store the video file; and
determining and acquiring the video file corresponding to the request information from the preset database.

6. A non-transitory computer-readable storage medium storing executable instructions, wherein the executable instructions are configured to:
receive request information sent by a client for acquiring a video file;
determine a video file corresponding to the request information according to the request information and encrypt the video file; and
send the encrypted video file to the client so that the client decrypts the encrypted video file and plays the decrypted video file.

7. The non-transitory computer-readable storage medium according to claim 6, wherein the video file is an M3U8 file.

8. The non-transitory computer-readable storage medium according to claim 7, wherein before determining a video file corresponding to the request information according to the request information, the executable instructions are further configured to:
parse the request information to determine whether the request information comprises an authorized device identifier, wherein the authorized device identifier is generated by a server and is a unique identifier of the client; and
ignore the request information when determining the request information does not comprise the authorized device identifier; and
the determining a video file corresponding to the request information according to the request information comprises:
determining the video file corresponding to the request information when determining the request information comprises the authorized device identifier.

9. The non-transitory computer-readable storage medium according to claim 6, wherein before encrypting the video file, the executable instructions are further configured to:
generate an encryption protocol of the video file, wherein the encryption protocol is used for instructing the client to decrypt the encrypted video file; and
the encrypting the video file comprises:
encrypting the video file according to the encryption protocol.

10. The non-transitory computer-readable storage medium according to claim 9, wherein the determining a video file corresponding to the request information according to the request information comprises:
traversing a preset database based on the request information, wherein the preset database is configured to store the video file; and
determining and acquiring the video file corresponding to the request information from the preset database.

11. An electronic device, comprising:
at least one processor; and
a memory communicably connected with the at least one processor for storing instructions executable by the at least one processor, wherein execution of the instructions by the at least one processor causes the at least one processor to:
receive request information sent by a client for acquiring a video file;
determine a video file corresponding to the request information according to the request information and encrypt the video file; and
send the encrypted video file to the client so that the client decrypts the encrypted video file and plays the decrypted video file.

12. The electronic device according to claim 11, wherein the video file is an M3U8 file.

13. The electronic device according to claim 12, wherein before determining a video file corresponding to the request information according to the request information, the instructions are executed to cause the at least one processor to:
parse the request information to determine whether the request information comprises an authorized device identifier, wherein the authorized device identifier is generated by a server and is a unique identifier of the client; and
ignore the request information when determining the request information does not comprise the authorized device identifier; and
the determining a video file corresponding to the request information according to the request information comprises:
determining the video file corresponding to the request information when determining the request information comprises the authorized device identifier.

14. The electronic device according to claim 11, wherein before encrypting the video file, the instructions are executed to cause the at least one processor to:
generate an encryption protocol of the video file, wherein the encryption protocol is used for instructing the client to decrypt the encrypted video file; and
the encrypting the video file comprises:
encrypting the video file according to the encryption protocol.

15. The electronic device according to claim 14, wherein the determining a video file corresponding to the request information according to the request information comprises:
traversing a preset database based on the request information, wherein the preset database is configured to store the video file; and
determining and acquiring the video file corresponding to the request information from the preset database.
